(19) United States
(12) Patent Application Publication
(10) Pub. No.: US 2009/0319952 A1
(43) Pub. Date: Dec. 24, 2009

(54) SUPPLIER BUILD STATUS VISIBILITY TOOL

(75) Inventor: Christopher G. Riegel, Saint Louis, MO (US)

Correspondence Address: LEE & HAYES, PLLC, 601 W. RIVERSIDE AVENUE, SUITE 1400, SPOKANE, WA, 99201, US

(73) Assignee: THE BOEING COMPANY, Chicago, IL (US)

(21) Appl. No.: 12/141,296

(22) Filed: Jun. 18, 2008

(51) Int. Cl. G06Q 10/00; G06F 3/048

(52) U.S. Cl. 715/841; 705/7

(57) ABSTRACT

Embodiments of techniques for providing a supplier build status visibility tool are disclosed. In one embodiment, a technique for providing a supplier build status visibility manager includes receiving build data from a supplier, where the build data includes a supplier element having a task and a task date. The build data may be associated with a project hierarchy tree of a plurality of elements organized under one or more projects to create project hierarchy build data. A preliminary supplier report may be generated for the supplier element in the project hierarchy build data and transmitted to the supplier for review during a quarantine period. Finally, a supplier build status visibility manager may be updated with the project hierarchy build data upon termination of the quarantine period.

### TECHNICAL FIELD

The present disclosure pertains to project management, and more specifically, to providing visibility and information associated with supplier build status.

### BACKGROUND

Management of large scale projects typically requires a large amount of information to be readily accessible in order to keep a project on schedule. In particular, it is important to locate problems early during a project to provide any necessary time and resource allocation to correct or mitigate the problems. As the supply chains for many projects are becoming global in nature, it is increasingly important to track many aspects of a large project to increase the likelihood that the project is completed within predetermined time constraints.

Typical project management tools require extensive updating and maintenance by a project manager. For example, a project manager may determine a number of tasks which need to occur before a subsequent task may take place, such as an assembly of sub-parts. The project manager may track timelines using ad hoc methods such as tracking dates on spreadsheets. In addition, the project manager may have to make direct or indirect inquiries to suppliers to obtain information about specific tasks. Large scale projects may include many communication barriers inherent in global commerce, including physical barriers (e.g., time zones, distance, etc.), cultural barriers (e.g., language, expectations, etc.), data barriers (e.g., data in different systems, formats, etc.), and the like, making project management difficult and time consuming.

### SUMMARY

Embodiments of techniques for providing a supplier build status visibility tool are disclosed. In one embodiment, a method for providing a supplier build status visibility manager includes receiving build data from a supplier, where the build data includes a supplier element having a task and a task date. The build data may be associated with a project hierarchy tree of a plurality of elements organized under one or more projects to create project hierarchy build data. A preliminary supplier report may be generated for the supplier element in the project hierarchy build data and transmitted to the supplier for review during a quarantine period. Finally, a supplier build status visibility manager may be updated with the project hierarchy build data upon termination of the quarantine period.

In another embodiment, a technique includes receiving supplier build data including tasks and task dates for an element. The supplier build data may be combined with a project hierarchy tree to create a project hierarchy build data for the element of a project. The element of the project that is delayed may be identified as a delayed element. At least one of the following operations may be conducted: 1) a historical analysis of the delayed element may be generated that aggregates delay causes over a plurality of delayed elements, and 2) the delayed element may be reassigned to a lower priority project.

In a further embodiment, a user interface to provide visibility to supplier build data includes build status visibility portion. The build status visibility portion may include a project hierarchy tree section having elements hierarchically arranged by a project, where the elements are navigable by a user. The build status visibility portion may further include an element production section to display tasks of an element selected in the project hierarchy tree section, the element production section including task unit fields populated with data received from a supplier. The user interface may also include a supplier portion which may include a quarantine section to display preliminary supplier data to a supplier during a quarantine period.

The features, functions, and advantages can be achieved independently in various embodiments of the present disclosure or may be combined in yet other embodiments.

### BRIEF DESCRIPTION OF THE DRAWINGS

Embodiments of techniques in accordance with the present disclosure are described in detail below with reference to the following drawings.

FIG. 1 shows an illustrative architecture to provide a supplier build status visibility tool in accordance with one or more embodiments;

FIG. 2 is a flow diagram of an illustrative process of providing a supplier build status tool;

FIG. 3 is a flow diagram of an illustrative process of reassignment of projects based on priority in accordance with one or more embodiments;

FIG. 4 is a flow diagram of an illustrative process of using historical data to validate estimations in accordance with one or more embodiments;

FIG. 5 is an illustrative user interface of a production view of a supplier build status visibility tool;

FIG. 6 is an illustrative user interface of a status entry view of a supplier build status visibility tool;

FIG. 7 is an illustrative user interface of a summary view of a supplier build status visibility tool;

FIG. 8 is an illustrative user interface of a quarantine view of a supplier build status visibility tool; and

FIG. 9 is an illustrative supplier build status visibility tool residing on a storage medium in accordance with one or more embodiments.

### DETAILED DESCRIPTION

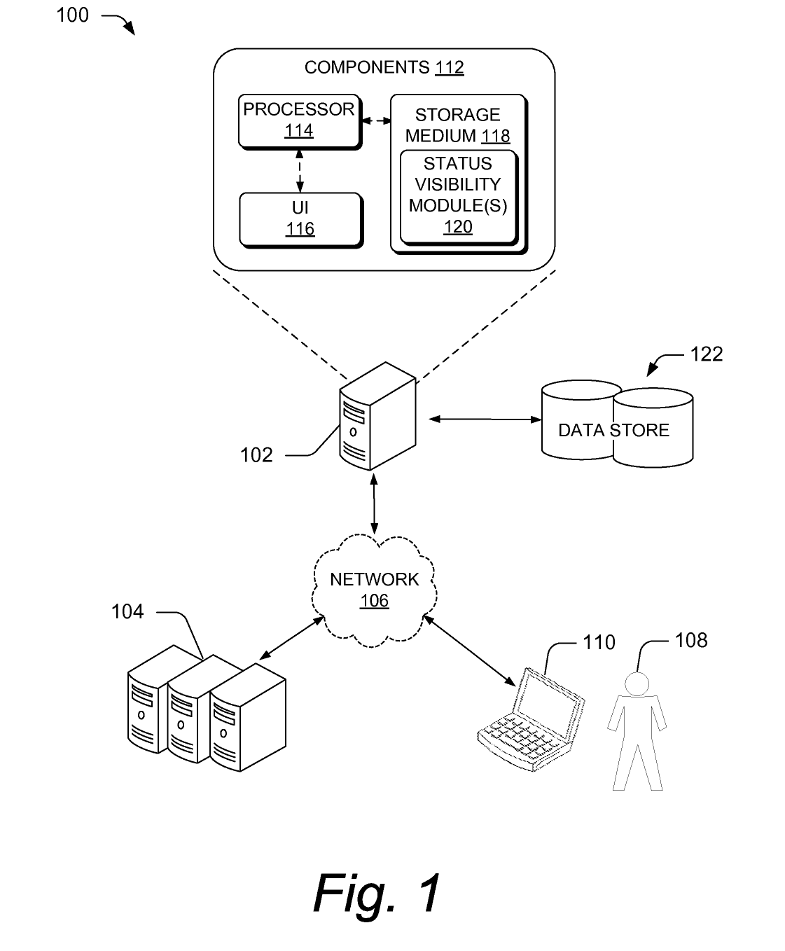

Techniques for providing a supplier build status visibility tool are described herein. Many specific details of certain embodiments of the disclosure are set forth in the following description and in FIGS. 1 through 9 to provide a thorough understanding of such embodiments. One skilled in the art, however, will understand that the present disclosure may have additional embodiments, or that the present disclosure may be practiced without several of the details described in the following description.

FIG. 1 shows an illustrative architecture 100 to provide a supplier build status visibility tool in accordance with one or more embodiments. The architecture 100 includes a project server 102 which may host the supplier build status visibility tool, among other tools, modules, and/or applications. The project server 102 may be in communication with supplier server(s) 104 via a network 106. The network may be a wired or wireless network including a wide-area network (WAN), local-area network (LAN), or other type of network. Additionally, the network 106 may be a secured network such as the advanced collaborative environment (ACE) network used by suppliers to securely transmit data to a project manager.

The supplier servers 104 may include data for projects, or portions of projects, conducted by the supplier. For example, the supplier servers 104 may run legacy applications which provide input, control, manipulation, or other tasks associated with products and/or services provided by the supplier. In some embodiments, the supplier servers 104 may be used to monitor workflow or other aspects of projects conducted by a supplier. For example, a program hosted by the supplier servers 104 may enable time stamping of an event associated with a project, such as the completion of a part, beginning of a sub-assembly, or other tasks.

In accordance with one or more embodiments, the supplier servers 104 may extract, manipulate, or otherwise compile supplier build data from legacy applications or other data sources for transmission to the project server 102 via the network 106. The transmission of data from the supplier servers 104 to the project server 102 may be batch processed so that the transmission occurs periodically, or the supplier servers 104 may continuously update the project server 102 with data. In some instances, the supplier server 104 may publish data in response to subscriptions issued by the project server 102. The supplier build data may be formatted using a predetermined format which may be readily accepted, validated, and/or processed by the project server 102. The formatting may occur on the supplier servers 104 or the project server 102.

In one or more embodiments, the project server 102 may enable a user 108 to manually transmit data with a computing device 110 to the project server 102 via the network 106. For example, the project server 102 may host a user input page which may enable a user, such as a small supplier with a relatively simple supply process, to input data for processing by the project server 102. For example, the user 108 may input project start dates, project end dates, and other project related data which may be manipulated, analyzed, or otherwise used by the project server 102 to provide a supplier build status visibility tool.

The project server 102 may include a number of components 112. The components 112 may include one or more processors 114 that are coupled to instances of a user interface (UI) 1 16. The UI 116 represents any devices and/or related drivers that enable the project server 102 to receive input from a user or other system, and to provide output to the user or other system. Thus, to receive inputs, the UI 116 may include keyboards or keypads, mouse devices, touch screens, microphones, speech recognition packages, imaging systems, or the like. Similarly, to provide outputs, the UI 116 may include speakers, display screens, printing mechanisms, or the like.

The project server 102 may include one or more instances of a computer-readable storage medium 118 that are addressable by the processor 114. As such, the processor 114 may read data or executable instructions from, or store data to, the storage medium 118. The storage medium 118 may contain one or more status visibility modules 120, which may be implemented as one or more software modules that, when loaded into the processor 114 and executed, cause the project server 102 to perform any of the functions described herein, such as to provide a supplier build status visibility tool in accordance with embodiments of the present disclosure. Additionally, the storage medium 118 may contain implementations of any of the various software modules described herein.

In some embodiments, the project server 102 may be in communication with data store(s) 122. The data stores 122 may support a project hierarchy tree, which may include a build structure for an assembly. The data stores 122 may store data received from the supplier servers 104 and data obtained from the user 108 via the computing device 1 10. Additionally any data extracted from the supplier servers 104 and users 108 may also be stored in the data stores 122. The data stores 122 may be proximally located or dispersed across a larger computing network.

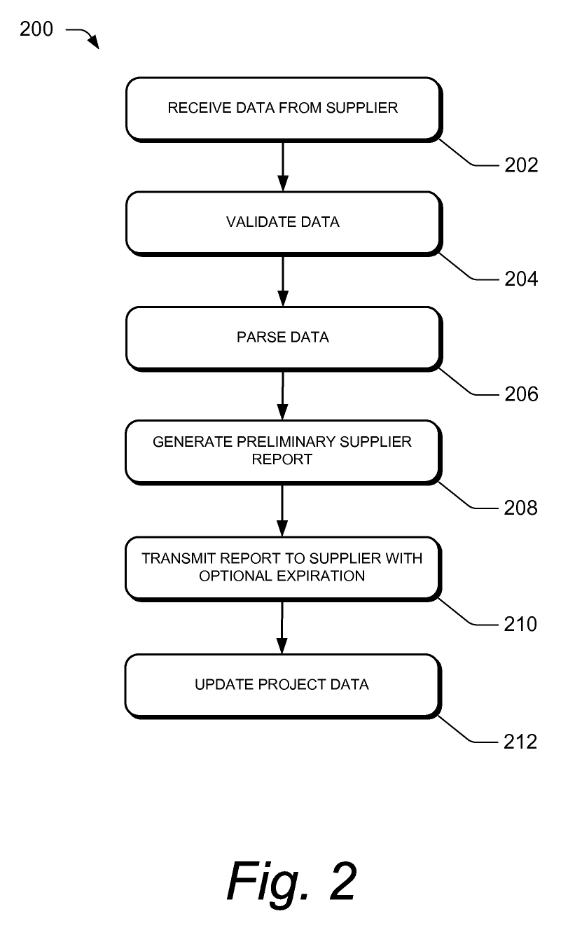

FIG. 2 is a flow diagram of an illustrative process 200 of providing a supplier build status tool. The process 200 is illustrated as a collection of blocks in a logical flow graph, which represent an exemplary sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described through this disclosure, in addition to process 200, shall be interpreted accordingly.

As shown in FIG. 2, the project server 102 may receive data from the supplier, such as the supplier servers 104 and/or the user 108, at 202. For example, the supplier servers 104 may upload data from a supplier legacy system, modify the data to a predetermined format which conforms to standards established for the project server 102, and periodically transmit the data to the project server.

In accordance with one or more embodiments, the data may be validated by the project server 102 at 204. The project server 102 may run one or more modules which check the authenticity, accuracy, or other aspects of the data. For example, the project server 102 may be used to ensure that time stamps for projects are chronologically consistent, such as a start date must precede a completion date and so forth. At 206, the data may be parsed by one or more modules running on the project server 102. The parsed data may be stored in the data stores 122 and used for further reporting.

In some embodiments, a preliminary supplier report may be generated at 208 by the project server 102. For example, the project server 102 may receive preliminary data from a supplier, validate and parse the data, then generate a report based on the data from the supplier. The preliminary data may be mapped to a project hierarchy tree, which may allow the supplier or a project manager to drill down to sub-assemblies, parts, or other elements, and vice versa. The report may be transmitted to the supplier as a feedback tool, to increase accuracy, or for other reasons.

One or more embodiments may include a quarantine period to enable the supplier to make changes to the preliminary data before the preliminary data is finalized and combined with other supplier data for use in project analysis by the project server 102. The supplier preliminary data may be inaccessible and kept confidential from viewing, integration, or other activities by an entity providing the status visibility modules 120 of the project server 102, which compiles data from a plurality of suppliers. However, the supplier preliminary data may be processed, analyzed, or otherwise used by the status visibility modules 120 to provide the supplier with a preliminary supplier report based on the supplier's own preliminary data during the quarantine period. For example, a supplier may have a quarantine period to review the preliminary supplier report. The review period may be terminated by an expiration of the quarantine period, by an approval (e.g., buyoff) by the supplier, or by another action.

At 210, the project server 102 may update project data. In some embodiments, the project data may be mapped to an element tree to create a project hierarchy tree. The project data may be stored in the data stores 122. The project data may be used continuously, such as being accessed by standardized or ad hoc queries, or may be used on a periodic basis to generate reporting to support a supplier build status visibility tool.

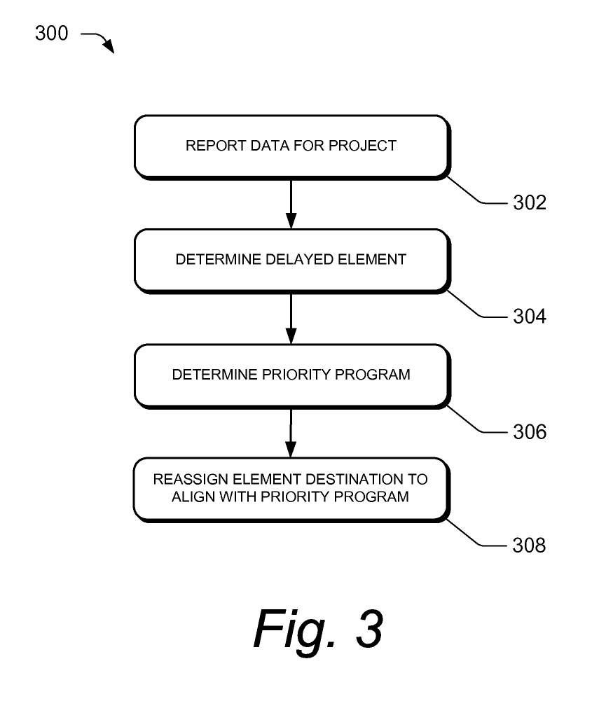

FIG. 3 is a flow diagram of an illustrative process 300 of reassignment of projects based on priority in accordance with one or more embodiments. The project server 102 may track, report, and manipulate data for multiple projects. Each project may include a number of elements such as parts, assemblies, or other components. Similar or identical elements may be used by different projects. In some instances, such as when a delay occurs, it may be advantageous to reassign the delayed part to a non-priority project from a priority project, thus potentially avoiding a delay in a priority project.

At 302, the project server 102 reports data for a project. The data may be organized as the project hierarchy tree which associates dates, status, and other data to an element of a project. At 304, an element may be identified as being delayed by the project server 102. For example, the supplier of the element may have missed a production deadline such as a start deadline, completion deadline, shipping deadline, or other deadline. Alternatively, the supplier may have transmitted an alert to the project server 102 to indicate an anticipated delay in the element. Regardless of the messaging, the element may be designated as delayed at 304, which may then prompt action to minimize a possible disruption to a project that may result from the delayed element.

In accordance with one or more embodiments, a program may be identified as a priority program at 306. For example, the project server 102 may enable each project to have a priority. For example, the priority may be relative to the other projects, a ranking, or a numeric scale, among other possible prioritization techniques. In some embodiments, the priority may be based on the completion date of the project.

At 308, the delayed element may be reassigned to another project based on the priority of the projects. For example, a high priority program that has a delayed element may have the delayed element reassigned to a project having a lower priority. In addition, the higher priority project may trade elements with a lower priority project to enable the high priority project to obtain a non-delayed element while assigning a delayed element to the lower priority project. In this sense, a high priority project having a delayed element may avoid delays by trading or otherwise transferring elements with lower priority projects when the lower priority project has a non-delayed element that is similar or the same as the delayed element. In an example, the reassignment of an element may include transmitting a message to the supplier to reroute the delayed element to another project (e.g., new shipping address, etc.) while similar action may occur to a complementary non-delayed element which is traded with the delayed element. Further embodiments may include automatic rerouting of delayed elements to lower priority projects, such as by using a reference table that includes delay thresholds to enable predetermined logical decision making for reassigning elements.

In some embodiments, the project server 102 may include the user interface 116 to enable a user to reassign elements quickly. In addition, the user interface 116 may be configured to suggest reassignments, alert a user to possible reassignments, or take other action to assist in facilitating reassignments of elements between projects.

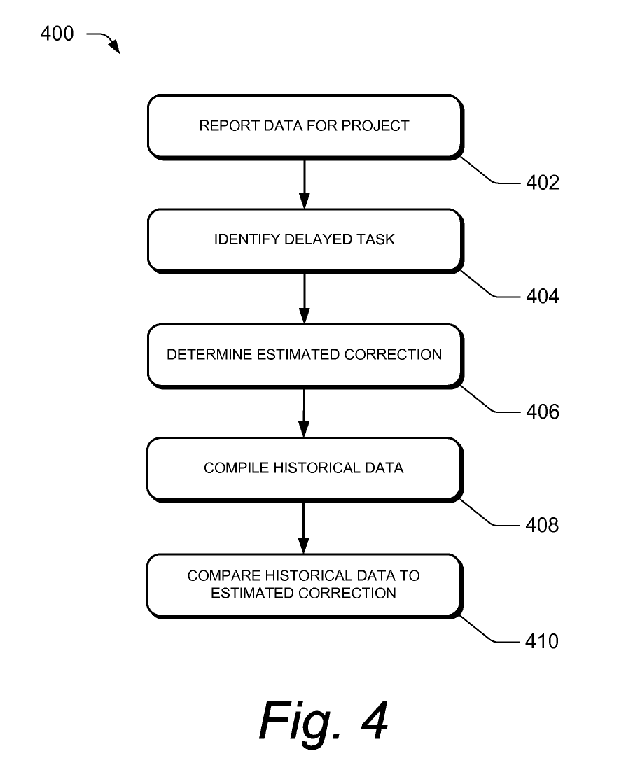

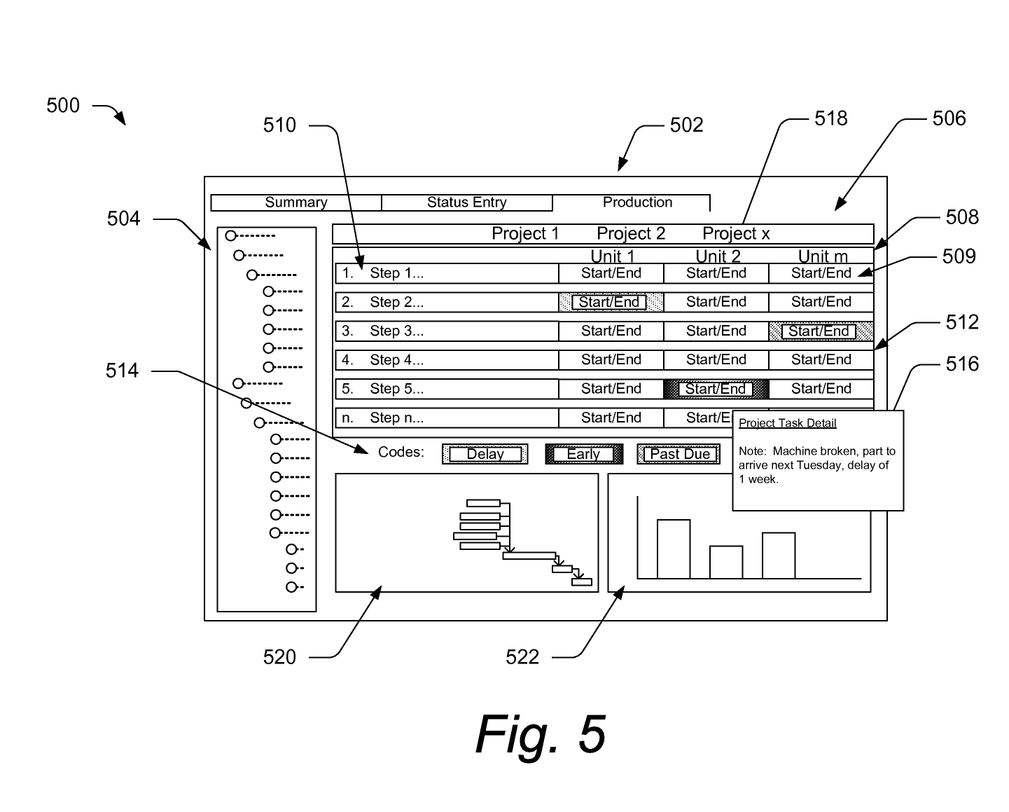

FIG. 4 is a flow diagram of an illustrative process 400 of using historical data to validate estimations in accordance with one or more embodiments. The process 400 enables analysis of a delayed task, which may result in a delayed element if the delayed task in not corrected before a deadline for completing the task and/or element. During a delay, a supplier may provide an estimate of a recovery date, which may indicate the amount of time necessary to correct the delay and complete an element. This estimate may be inaccurate for various reasons, such as being shorter than an actual duration because of unwarranted optimism, poor or inaccurate assumptions, or for other reasons. The process 400 enables validation of the estimate by leveraging historical data extracted by the project server 102.

In accordance with embodiments, the project server 102 reports data for a project at 402. At 404, a delayed task is identified by the project server 102. For example, the project server 102 may provide a summary of delayed tasks or otherwise alert a user of a delayed task. At 406, an estimated correction may be received by the project server 102.

The project server 102 may compile historical data at 408 to use in an analysis of a validity of the estimated correction. For example, the project server 102 may query similar or identical elements to determine task duration or cycle time, compare other estimates from the same supplier to assess prior estimate accuracy, or compile other relevant historical information to assess the validity of the estimated correction. Statistical information may be used to present further data, such as a confidence interval for timely correction of the delayed task. At 410, the historical data may be compared to the estimated correction to assist a user in decision making regarding project management. For example, the user may desire to initiate a reassignment using the process 300 of FIG. 3. In some embodiments, the historical data may be presented in the user interface 116 for display to the user.

FIG. 5 is an illustrative user interface 500 of a production view of a supplier build status visibility tool. The user interface 500 may include tabs 502 which enable a user to access different portions of the user interface 500. As shown in FIG. 5, the user interface 500 shows the tab 502 labeled “production,” although other names or presentation techniques may be used to present the data shown in FIG. 5.

The user interface 500 includes a project hierarchy tree section 504. In one or more embodiments, the project hierarchy tree section 504 includes a graphical representation of the elements of one or more projects. Each element may be displayed under an assembly, which may further roll up to larger assemblies and ultimately a competed project, such as vehicle, a building, a computer program, or another outcome of the project. The project hierarchy tree section 504 may enable a user to drill up or drill down through the project to access data about particular elements.

In one or more embodiments, the user interface 500 may include an element production section 506. The element production section 506 may include data about an element included in the project hierarchy tree section 504. For example, a user may select an element from the project hierarchy tree to obtain information for the select element in the element production section 506. The element production section 506 may include units 508 of the element, tasks 510 for the element, and task unit fields 512, among other possible relevant informational data associated with the selected element. The tasks 510 may include any tasks that are tracked for the processing of the element. Each task has a task unit field 512 for each unit of the units 508. The task unit field 512 may include key dates, such as a scheduled start date, an actual start date, a scheduled finish date, an actual finish date, or other relevant date information. The task unit field 512 may be populated by information received by the project server 102 from the supplier server 104 and/or the user 108.

The task unit field 512 may include a code 514 to provide a visual cue of the status of the task for a particular unit. The codes 514 may include a delay start code, an early start code, a past due code, or other codes which indicate information about the status of a task for a unit. The codes 514 enable a user to quickly determine which tasks may be problematic, such that the task may result in a delayed element.

In some embodiments, the task unit field 512 may be selected to display additional information 516 related to the task unit field. The additional information 516 may include an alert from the supplier, a reason for the code 514, an estimated delay or recovery time for a delayed task, or other information related to the task unit field 512.

The user interface 500 may also include a project selector 518. As discussed above, some elements may be used in more than one project. The project selector 518 may enable a user to navigate to another project which also uses a particular element. In some embodiments, the project selector 518 may enable a user to reassign a delayed element to another project, such as by the process 300 of FIG. 3.

In accordance with one or more embodiments, the user interface 500 may include a project flow section 520 and a historical analysis section 522. The project flow section 520 may be a graphical representation of the tasks 510 in the element production section 506. For example, the project flow section 520 may include a Gantt chart. The historical analysis section 522 may include information for a selected task of the tasks 5 10. For example, a user may select a task to initiate a new historical analysis. The historical analysis section 522 may present information on the task based on historical information, such as average historical cycle time for the selected task. In some embodiments, the historical analysis section 522 may present a bar graph of historical task times for the selected task, although other relevant historical data which may provide advantageous user information may be displayed in the historical analysis section 522, such as data associated with the process 400 of FIG. 4.

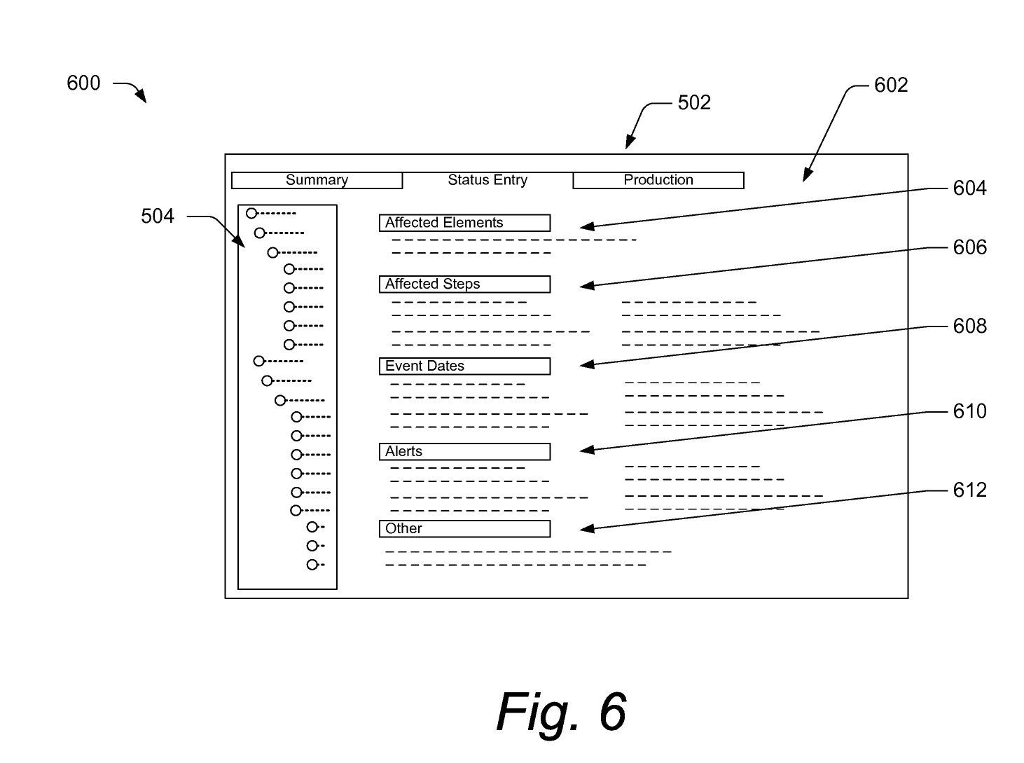

FIG. 6 is an illustrative user interface 600 of a status entry view of a supplier build status visibility tool. The user interface 600 may enable a user, such as the user 108 of FIG. 1, to transmit data to the project server 102. The user interface 600 may include a status entry section 602, which may be selectable from the tab 502.

In accordance with one or more embodiments, the status entry section 602 may include an affected elements section 604. The affected elements section 604 may enable a user to select a unit of an element, or otherwise designate an intended element. An affected step section 606 may include a listing of the steps associated with the affected element. For example the affected steps may be predetermined based on the affected element, or the affected steps may be modified or created for an affected element. An event dates section 608 may enable a user to add, modify, or remove dates for the affected steps. An alerts section 610 may enable a user to add alerts, such as notes, warning, or other messages which may be associated with an element, step, and/or event date. For example, the alert section may be used by the additional information 516 of user interface 500. An “other” section 612 may be used to enable the user to input other data which may be relevant to aspects of the project, element, steps, dates, and/or alerts.

In some embodiments, the user interface 600 may enable the user 108 or another supplier to report an anomaly. For example, the user 108 may report that an element will be completed on time but has a flaw, such as a blemish. A supplier may also report that an element will be shipped incomplete to alert a purchaser of what additional work is required for an element. A supplier may also report that an element will be delayed to preemptively warn a project manager. For example, the supplier may transmit an alert which informs a user that a machine is broken and will be off-line for a specified time period.

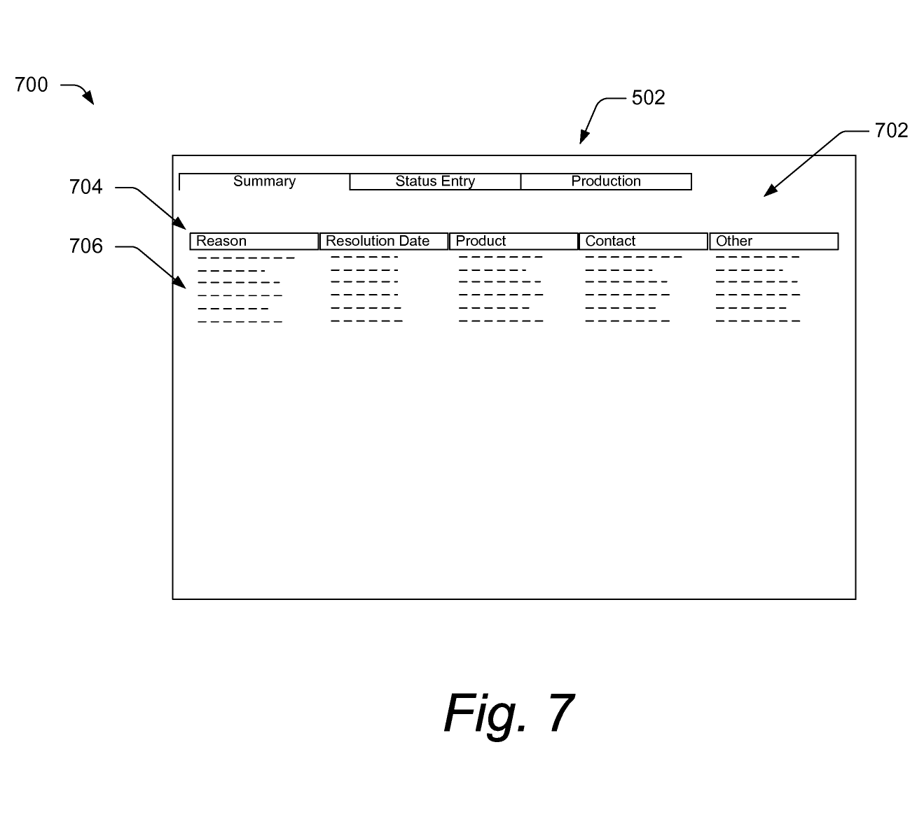

FIG. 7 is an illustrative user interface 700 of a summary view of a supplier build status visibility tool. The user interface 700 may enable a user (e.g., project manager, analyst, etc.) to view data using the project server 102. The user interface 700 may include a summary section 702, which may be selectable from the tab 502. The summary section 702 may include a listing of alerts, delays, or other critical information which may be important for viewing by the user. The summary section 702 may optionally be filtered to only show information relevant to a specific user. The fields 704 may be used to organize the summary section 702. Each field may include data 706. For example, the fields 704 may include a reason, a scheduled resolution date, a product (project), a contact, and an “other” field. More or fewer fields may be included in the summary section 702 to accommodate a conveyance of the data 706 to the user to enable the user to view a summary of alerts, delays, etc. associated with the projects managed using the project server 102.

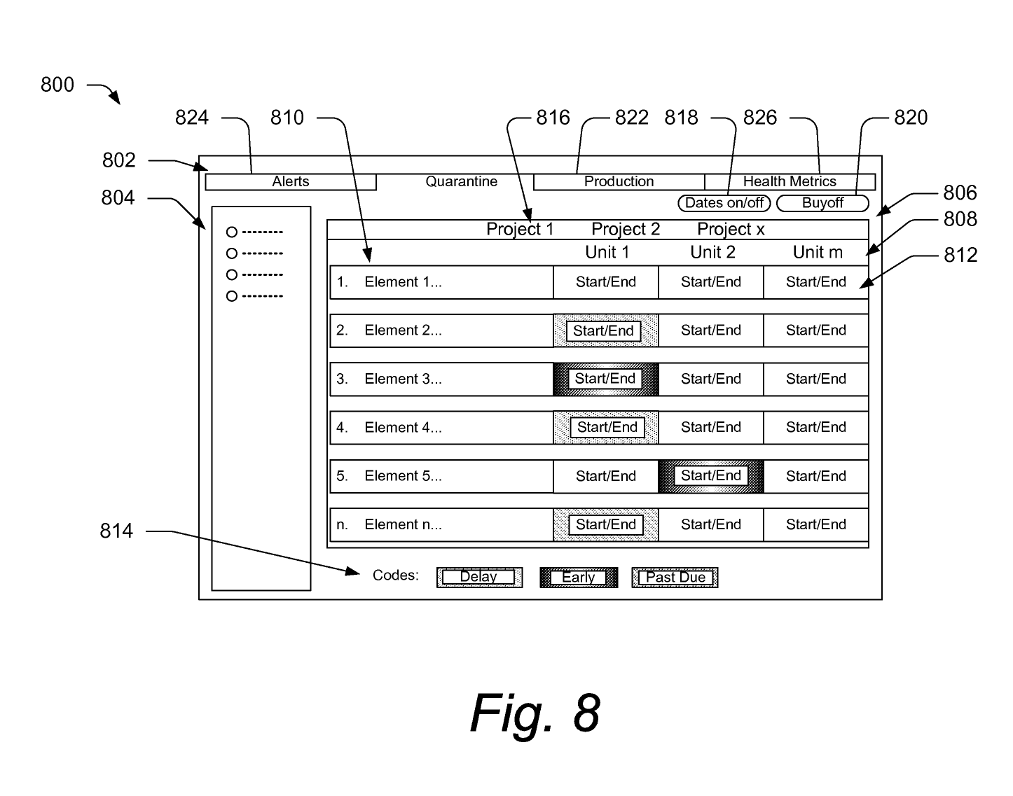

FIG. 8 is an illustrative user interface 800 of a quarantine tab of a supplier build status visibility tool. The user interface 800 may be viewed by the supplier to gain visibility to information the suppler submitted to the project server 102 after a process by the status visibility modules 120. As discussed in the operation 208 of the process 200, a quarantine period may enable the supplier to make changes to preliminary data that the supplier uploads to the project server 102. In some embodiments, the supplier may automatically or manual upload preliminary data to the project server 102, which may then produce reporting based on the preliminary data. The project server 102 may transmit the reporting based on the preliminary data back to the supplier for final approval. The entity receiving the data from the supplier may not view or use the preliminary data until the quarantine period ends, such as by an approval by the supplier, an expiration of a review period, or another action. Thus, the supplier may submit data to the project server 102 that is confidential from the entity compiling supplier information until the data has passed through the quarantine period.

The user interface 800 may include tabs 802 which enable the supplier to access different portions of the user interface 800. As shown in FIG. 8, the user interface 800 shows the tab 802 labeled “quarantine,” although other names or presentation techniques may be used to present the data shown in FIG. 8. The user interface 800 includes a project section 804 which may group projects for a supplier. An element production section 806 includes data about an element included in the project section 804, which is updated from preliminary data sent from the supplier to the project server 102. Thus, the data displayed in the quarantine is subject to approval by the supplier, an expiration of a review period, or another action before the entity compiling supplier data may view or utilize the data.

The element production section 806 may include units 808 of the element, and element description 810 for the element, and task unit fields 812, among other possible relevant informational data associated with the selected element. The task unit fields 812 may reflect the preliminary data and be subject to the quarantine period. The task unit field 812 may include a code 814 to provide a visual cue of the status of the task for a particular unit. The user interface 800 may also include a project selector 816. As discussed above, some elements may be used in more than one project.

The user interface 800 may include supplier specific features for the quarantine tab. A date control 818 may enable a supplier to toggle between showing date detail in the task unit fields 812 or in other location and relying on the codes 814.

In accordance with one or more embodiments, a buyoff control 820 may enable the supplier to submit the preliminary data shown by the quarantine tab for reporting and processing by the project server 102 with data from other suppliers. Thus, after the supplier completes a buyoff process, the entity receiving the data may have access to this data. In some embodiments, more than one representative for the supplier may have to accept (i.e., buyoff) the preliminary data, such as a production operation representative, a quality control representative, a management representative, and so forth. The user interface 800 may track the buyoff status for each required person, and send updates, reminders, etc. as necessary.

The user interface may include a production tab 822 which displays data which has passed through the quarantine. An alerts tab 824 may provide a summary of selected data from the preliminary data, which may be displayed in the quarantine tab. A health metrics tab 826 may enable the supplier to provide additional information to the project server 102, such as to provide more information about delays, project details, and the like.

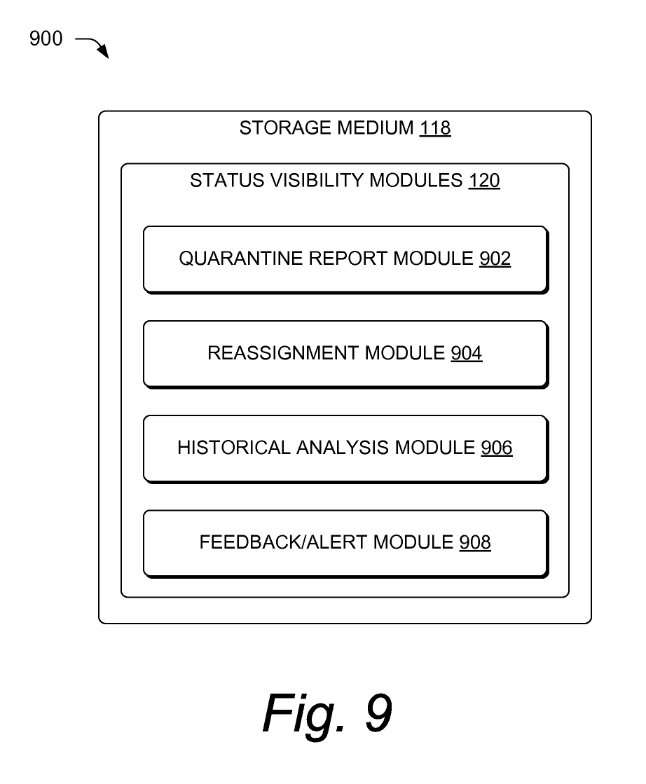

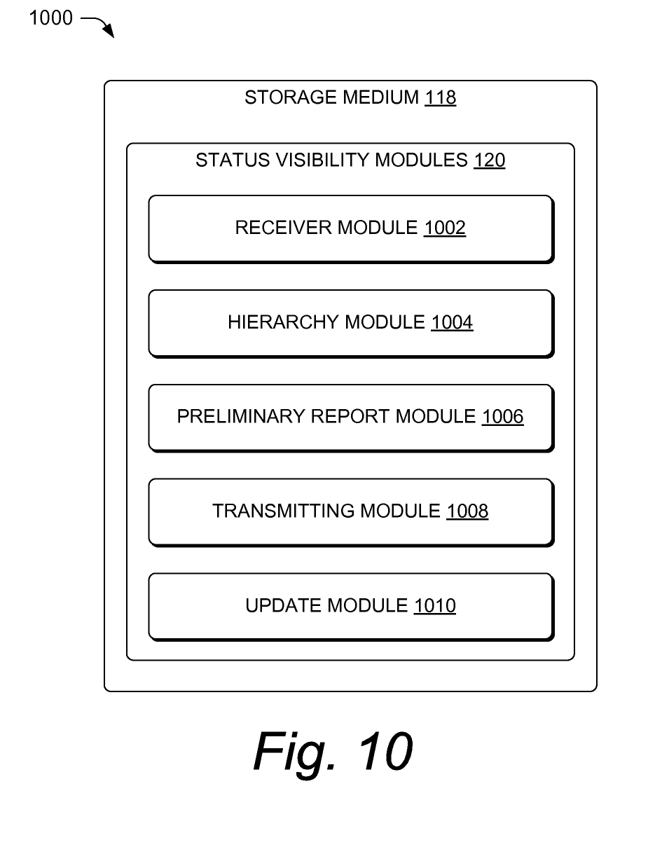

FIG. 9 is an illustrative supplier build status visibility tool (SBSV tool) 800 residing on a storage medium in accordance with one or more embodiments. The SBSV tool 800 may reside on the storage medium 118 of FIG. 1 and include the status visibility modules 120, which will be discussed in turn.

In accordance with one or more embodiments, a quarantine report module 902 may facilitate a process of generating data for a supplier for review prior to publication of the data by the project server 102. For example, the quarantine report module 902 may support at least a portion of the process 200, such as the operation 208 of generating a preliminary supplier report, which may be reviewed by the supplier and approved by a deadline by either action or inaction by the supplier. In addition, the quarantine report module 902 may enable providing the quarantine tab of the user interface 800, as shown in FIG. 800.

In some embodiments, a reassignment module 904 may support the process 300 of FIG. 3. For example, the reassignment module may enable automatic and/or manual reassignment (e.g., trading, allocation, etc.) of elements between projects. A historical analysis module 906 may support the process 400 of FIG. 4. For example, the historical analysis module 906 may create data based on historical data to enable a user to make an educated decision, such as whether to reassign an element using the reassignment module 904.

In accordance with one or more embodiments, a feedback/alert module 908 may support aspects of the user interface 500 of FIG. 5. For example, an alert may be displayed in the additional information 516 or may trigger application of the codes 514. The user interface 600 of FIG. 6 may be supported by the feedback/alert module 908, in particular the alert section 610 and the other section 612, which may communicate important information to a user (e.g., project manager) regarding supplier build status of an element. The feedback/alert module 908 may also be used to generate the user interface 700 of FIG. 7. For example, one or more of the fields 704, such as the reason field, contact field, or another field, may be manipulated by the feedback/alert module 908 to communicate information to the user.

While preferred and alternate embodiments of the disclosure have been illustrated and described, as noted above, many changes can be made without departing from the spirit and scope of the disclosure. Accordingly, the scope of the disclosure is not limited by the disclosure of these preferred and alternate embodiments. Instead, the disclosure should be determined entirely by reference to the claims that follow.

1. A method of providing supplier build status visibility, the method comprising:
receiving build data from a supplier including a supplier element;
associating the build data to a project hierarchy tree of a plurality of elements organized under one or more projects to create project hierarchy build data;
generating a preliminary supplier report for the supplier element in the project hierarchy build data;
transmitting the preliminary supplier report to the supplier for review during a quarantine period; and
updating a supplier build status visibility manager with the project hierarchy build data upon termination of the quarantine period.

2. The method of claim 1, further comprising validating the project hierarchy build data before updating the supplier build status visibility manager by receiving updated build data from the supplier in response to the preliminary supplier report.

3. The method of claim 1, wherein the termination of the quarantine period includes at least one of an approval by the supplier and an expiration of a review period.

4. The method of claim 1, further comprising generating a historical analysis from the project hierarchy build data based on a task and a task date of the supplier element.

5. The method of claim 1, further comprising reallocating the supplier element from a first project to a second project based on a project priority.

6. The method of claim 5, wherein the reallocating the supplier element from the first project to the second project is automatic based on a prioritization.

7. The method of claim 1, further comprising generating an alert associated with the supplier element that is delayed, the alert being coded to provide a visual cue to a user.

8. One or more computer readable media comprising computer-executable instructions that, when executed by a computer, perform acts comprising:
receiving supplier build data including tasks and task dates for an element;
combining the supplier build data with a project hierarchy tree to create a project hierarchy build data for the element of a project;
identifying the element of the project that is delayed as a delayed element; and
conducting at least one of:
generating a historical analysis of the delayed element that is delayed, and
reallocating the delayed element to a lower priority project.

9. The one or more computer readable media of claim 8, wherein the identifying the delayed element includes identifying a task that has not been completed by a predetermined deadline.

10. The one or more computer readable media of claim 9, wherein the predetermined deadline includes a scheduled start deadline and a scheduled completion deadline.

11. The one or more computer readable media of claim 8, wherein the reallocating the delayed element to the lower priority project includes referencing a prioritization schedule for the project.

12. The one or more computer readable media of claim 8, wherein the receiving supplier build data includes receiving the supplier build data in a predetermined standardized format for compilation by a project server.

13. The one or more computer readable media of claim 8, further comprising generating a preliminary supplier report from the project hierarchy build data from a supplier, the preliminary supplier report being reviewable by the supplier during a quarantine period, and the project hierarchy build data from the supplier being confidential until the termination of the quarantine period.

14. The one or more computer readable media of claim 13, wherein the quarantine period terminates with at least one of the acceptance of the supplier report or the expiration of a review period.

15. The one or more computer readable media of claim 13, wherein the supplier report is modifiable by the supplier to update the project hierarchy build data.

16. A user interface to provide visibility to supplier build data, the user interface comprising:
a build status visibility portion including:
a project hierarchy tree section having elements hierarchically arranged by a project, the elements being navigable by a user, and
an element production section to display tasks of an element selected in the project hierarchy tree section, the element production section including task unit fields populated with data received from a supplier; and
a supplier portion including a quarantine section to display preliminary supplier data to a supplier during a quarantine period.

17. The user interface of claim 16, wherein the display of tasks includes tasks which are tracked during an operation of the element.

18. The user interface of claim 16, wherein the build status visibility portion further includes a historical analysis section to provide historical data for information selected in the element production section.

19. The user interface of claim 16, wherein the project hierarchy tree section enables a user to drill up or drill down through the elements associated with a plurality of projects.

20. The user interface of claim 16, wherein the task unit fields include a start date and an end date.

21. A supplier build status visibility system, comprising:
a receiver module to receive build data from a supplier including a supplier element;
a hierarchy module to associate the build data to a project hierarchy tree of a plurality of elements organized under one or more projects to create project hierarchy build data;
a preliminary report module to generate a preliminary supplier report for the supplier element in the project hierarchy build data;
a transmitting module to transmit the preliminary supplier report to the supplier for review during a quarantine period; and
an update module to update the project hierarchy build data upon termination of the quarantine period.
